(19) United States
(12) Patent Application Publication
(10) Pub. No.: US 2016/0350201 A1
(43) Pub. Date: Dec. 1, 2016

(54) ETL DATA FLOW DESIGN ASSISTANCE THROUGH PROGRESSIVE CONTEXT MATCHING

(71) Applicant: International Business Machines Corporation, Armonk, NY (US)

(72) Inventors: Lawrence A. GREENE, Plainville, MA (US); Eric A. JACOBSON, Arlington, MA (US); Yong LI, Newton, MA (US); Xiaoyan PU, Chelmsford, MA (US)

(21) Appl. No.: 14/723,239

(22) Filed: May 27, 2015

(51) Int. Cl. G06F 11/36; G06F 17/30; G06F 9/45

(52) U.S. Cl. CPC G06F 11/362; G06F 8/41; G06F 17/30389

(57) ABSTRACT

The present disclosure provides a method and apparatus for re-using existing data flow design jobs in a data integration design environment (IDE). An example method generally includes receiving input placing one or more data flow operators on a design canvas of the IDE, searching a database of existing data flow job designs for existing data flow job designs that include the one or more data flow operators, and displaying a list of the existing data flow job designs that include the one or more data flow operators.

### BACKGROUND

The present invention relates to integrated development environment (IDE) tools, and more specifically, to extract, transform, load (ETL) data flow design assistance through progressive context matching.

An integrated development environment (IDE) or an interactive development environment is a software application that provides tools for combining data residing in different sources and providing users with a unified view of the data. IDE tools are designed to maximize user productivity by providing components with similar user interfaces, in which all development may be performed. This software typically provides features for authoring, modifying, compiling, deploying and debugging data flow jobs.

For example, in a typical data integration design environment, developers may be provided with a canvas or a form, a list of operators/widgets/data elements and a hierarchical list of existing data flow job designs. Some more advanced design environments may provide users with the ability to customize the operators into “My Favorites’, or provide some sort of job template to help speed job design.

### SUMMARY

One embodiment of the present invention includes a method for re-using existing data flow design jobs in a data integration design environment (IDE). The method generally includes receiving input placing one or more data flow operators on a design canvas of the IDE, searching a database of existing data flow job designs for existing data flow job designs that include the one or more data flow operators, and displaying a list of the existing data flow job designs that include the one or more data flow operators.

Another embodiment of the present invention includes a processor and a memory storing a program, which, when executed on the processor, performs an operation for re-using existing data flow design jobs in a data integration design environment (IDE). The operation generally includes receiving input placing one or more data flow operators on a design canvas of the IDE, searching a database of existing data flow job designs for existing data flow job designs that include the one or more data flow operators, and displaying a list of the existing data flow job designs that include the one or more data flow operators.

Still another embodiment of the present invention provides a computer-readable storage medium having instructions, which, when executed on a processor, performs operations for re-using existing data flow design jobs in a data integration design environment (IDE). The operation generally includes receiving input placing one or more data flow operators on a design canvas of the IDE, searching a database of existing data flow job designs for existing data flow job designs that include the one or more data flow operators, and displaying a list of the existing data flow job designs that include the one or more data flow operators.

### BRIEF DESCRIPTION OF THE DRAWINGS

FIG. 1 illustrates an example computing environment, according to certain aspects of the present disclosure.

FIG. 2 illustrates a design environment for re-using existing exchange-transform-load (ETL) data flow job designs, according to certain aspects of the present disclosure.

FIG. 3A illustrates an example of an ETL data flow job design, according to certain aspects of the present disclosure.

FIG. 3B illustrates a design environment for re-using existing ETL data flow job designs, according to certain aspects of the present disclosure.

FIGS. 4-5 illustrate a design environment for re-using existing ETL data flow job designs, according to certain aspects of the present disclosure.

FIG. 6 illustrates index tables over which an existing data flow job design may be saved, according to certain aspects of the present disclosure.

FIG. 7 illustrates an example flow diagram for leveraging existing data flow job designs, according to certain aspects of the present disclosure.

FIG. 8 illustrates an example computing system, according to certain aspects of the present disclosure.

To facilitate understanding, identical reference numerals have been used, where possible, to designate identical elements that are common to the figures. It is contemplated that elements disclosed in one embodiment may be used on other embodiments without specific recitation.

### DETAILED DESCRIPTION

Embodiments presented herein describe techniques for assisting data flow design through progressive context matching in a data integration design environment. As noted, in a typical data integration design environment, developers may interact with a digital canvas or form, a list of operators/widgets/data elements and a hierarchical list of existing job designs. Some more advanced design environments may allow users to customize operators into a “My Favorites” category, or provide some sort of job template to assist with job design. However, while helpful, these features do not provide a mechanism to for re-using existing extract-transform-load (ETL) data flow job designs or the knowledge to facilitate design reuse. It should be noted that the terms “ETL data flow job design”, “data flow job design”, “job design”, and/or “job”, as used herein, may be used interchangeably. It should also be noted that the terms “operator” and “data flow operator”, as used herein, may be used interchangeably.

Aspects of the present disclosure provide techniques for leveraging existing job design artifacts so that developers may become more productive as more and more jobs are developed and executed in the data integration design environment.

Embodiments presented herein provide techniques that allow a user to search and view existing job designs that have similar patterns to a job that the user is developing. Such techniques involve the data IDE system evaluating a current ETL data flow job as it is designed as a trigger to automatically suggest a list of existing job designs with similar context for reference. For example, in some cases, as the user adds an operator to a current job design, the system may find relevant job designs for reuse. Additionally, as the user specifies more detail about the operators (e.g., dataset schemas, job parameters, and/or operator properties) the system may automatically refine the search and display the most relevant job designs from a database which use the same dataset schema, job parameters, and/or operator options. The user may then choose to partially or completely reuse existing job designs in order to speed up the job development process.

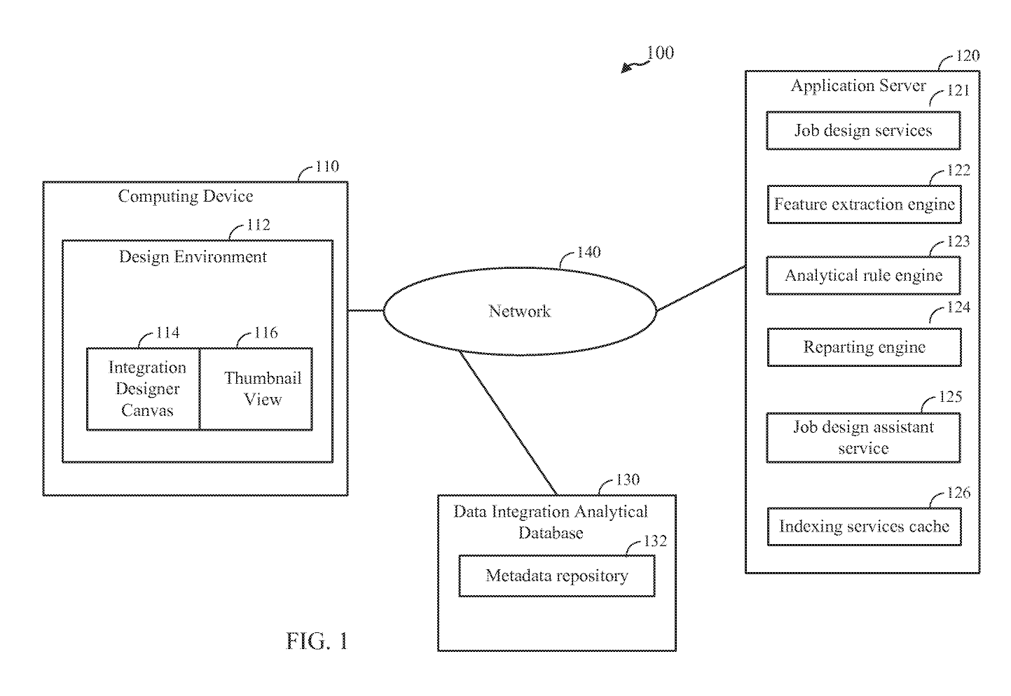

FIG. 1 illustrates an example computing environment 100, which may allow for the leveraging of existing job designs in an integrated design environment (IDE) in order to increase efficiency and productivity, according to certain aspects. As shown, the computing environment includes a computing device 110, an Application Server 120, a Data Integration Analytical Database 130, and a data communications network 140. As shown, the computing device 110, Application Server 120, and Data Integration Analytical Database 130 may be interconnected via the data communications network 140. For example, the data communications network 140 may include the Internet, an intranet, a local area network, etc.

Computing device 110 may be a personal computer, workstation, mobile device, or any other computing device able to access the data communications network 140. Further, computing device 110 may include a design environment 112 (e.g., an IDE) used to compose data flow job designs and be configured to assist in re-using existing data flow job designs, as described herein. As shown, design environment 112 includes an Integration Designer Canvas 114 and a thumbnail view 116. The Integration Designer Canvas 114 provides an environment for designing data integration (i.e., data flow) jobs. The thumbnail view 116 provides a list of existing jobs designs with similar context, which will be discussed in greater detail below. The Design Environment 112 may be a client based design environment stored locally on a client's computing device or a web-based/cloud-based design environment stored on a server (e.g., the Application Server 120) accessible via the data communications network 140.

As noted, the computing environment 100 includes a Data Integration Analytical Database 130, which may comprise a metadata repository 132. The Data Integration Analytical Database 130 stores job analytics information for design assistance needs. According to certain aspects, the metadata repository 132 may store design time metadata about job designs, such as the project name, job name, the stages in each job, and/or link information (e.g., schema definitions).

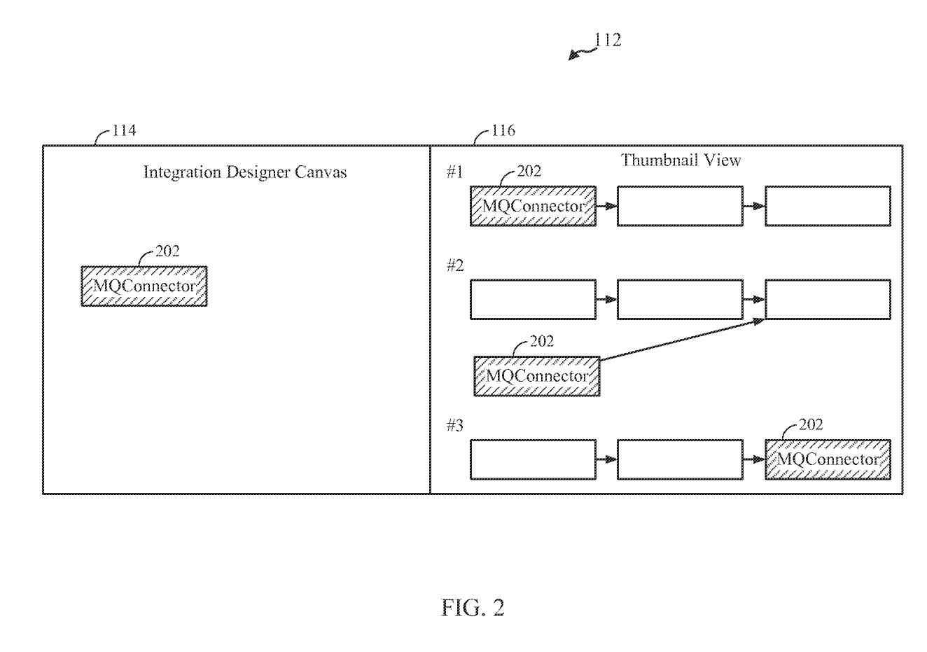

As shown, the computing environment 100 also includes an Application Server 120, which includes job design services 121, a feature extraction engine 122, an analytical rule engine 123, a reputing engine 124, a job design assistant service 125, and an indexing services cache 126. According to certain aspects, the application server 120 provides design time services, such as retrieving and saving job designs (developed using the design environment 112) in the Data Integration Analytical Database 130, managing user sessions, locking, etc. For example, as a user adds context (e.g., operators) to the Integration Designer Canvas 114, the Application Server 120 may query (e.g., via the Job Design Assistant Service 125) the Data Integration Analytical Database 130 for existing jobs stored in the metadata repository 132 that match the context of the job currently being designed. The Application Server 120 may retrieve a list of existing jobs with similar context relay the list to the computing device 110, which may be displayed in the thumbnail view 116. This process is described in greater detail below with reference to FIGS. 2-6.

FIG. 2 illustrates a design environment 112 that may be configured to leverage existing job designs to increase efficiency and productivity, according to certain aspects.

According to certain aspects, the job design assistant service 125 may be enabled at job design time (i.e., when the user is designing a job). When enabled, the job design assistant service 125 may perform a set of range match operations based on user-specified requirements to determine a list of existing job designs relevant to a design being authorized on a design canvas.

For example, when a user starts with an empty Integration Designer Canvas 114, no search execution by the job design assistant service 125 is performed. However, when the user drags a first operator onto the Integration Designer Canvas 114, the job design assistant service 125 may query the Data Integration Analytical Database 130 to find a list of jobs that use the current operator and may display the first five to ten jobs, for example, in the thumbnail view 116. The user may be allowed to scroll through the list, if necessary, to see more job designs. In some cases, the current operator may be highlighted in each job in the thumbnail view.

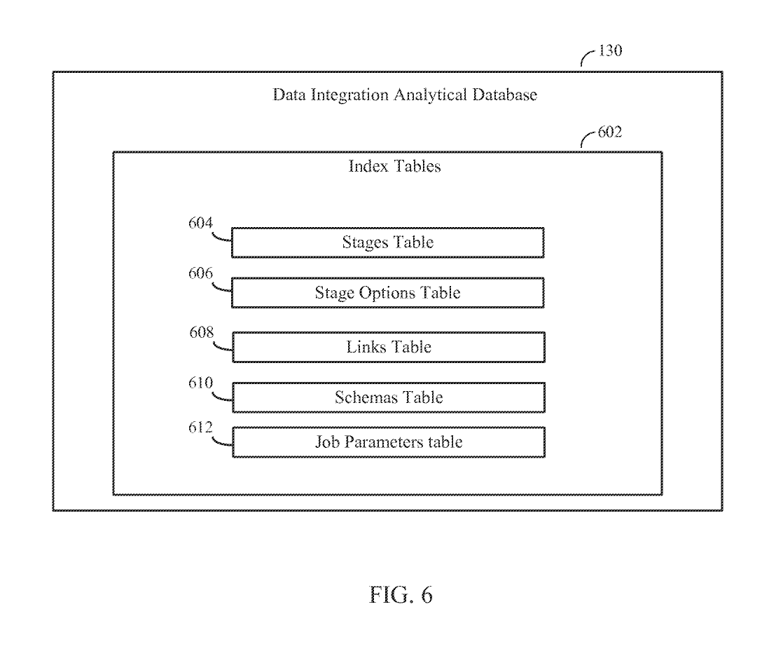

For example, as illustrated in FIG. 2, once a user places an operator (e.g., a message queue (MQ) connector) on the Integration Designer Canvas 114, the job design assistant service 125 searches the Data Integration Analytical Database 130 for existing data flow job designs that contain the MQConnector. A list of existing data flow job designs containing the MQConnector is then displayed in the thumbnail view 116 as shown. For example, as illustrated, a list of three distinct jobs is displayed in the thumbnail view 116, each of which contains the MQConnector operator 202. In some cases, the list may be ordered based on a measure of how well the existing data flow job designs match one or more properties of the operator, as described below with reference to FIG. 6.

According to certain aspects, as the user continues to add additional operators, the job design assistant service 125 continues to query the Data Integration Analytical Database 130 to identify existing jobs which use the operators in the canvas (in the same sequence) on the Integration Designer Canvas 114. A list of the top 5-10 jobs is presented in the thumbnail view 116. For instance, if a user adds an MQConnector and then a Transformer operator onto the Integration Designer Canvas 114, the job design assistant service 125 finds jobs that contain the MQConnector followed by a Transformer. The resulting list of jobs is displayed in the thumbnail view 116. Note, as described below, if an exact match of operators and connections between operators is unavailable, the job design assistant service 125 may broaden the search to identify existing jobs, for example, whose link metadata (e.g., schema definitions) may be a subset of the defined link metadata.

According to certain aspects, as the user connects operators (e.g., to connect a data source to a data target) on the Integration Designer Canvas 114, the job design assistant service 125 takes this input to filter the existing job designs and select only those that use all the operators on the Integration Designer Canvas 114 and have the same link relationship (Source-->Target) and link metadata (e.g., schema definitions). Again, if possible, the job design assistant service 125 may then display the top 5-10 (or more) jobs in the thumbnail view 116.

If no existing job designs match the conditions (e.g., the operators and their link relationships) on the Integration Designer Canvas 114, the job design assistant service 125 may query Data Integration Analytical Database 130 for any existing job designs that use all operators on the design canvas, have the same link relationship (Source-->Target), but whose link metadata (e.g., schema definitions) may be a subset of the defined link metadata. The job design assistant service 125 may then display a list of jobs in the thumbnail view 116.

If there are still no existing job designs, the job design assistant service 125 may use a selected operator and an associated input schema(s) to query Data Integration Analytical Database 130 for a list of candidate jobs that use the same operator and whose link metadata (e.g., schema definitions) either directly matches or is a subset of the defined link metadata. The job design assistant service 125 may then display such matching jobs in the thumbnail view 116.

As discussed above, the job design assistant service 125 performs searching/querying, by default, on a per link basis (i.e., the job design assistant service 125 will only look at two operators and how they are linked together at a time). In some cases, to refine the match, the user may select multiple links as a matching unit. The job design assistant service 125 returns jobs that include the required links.

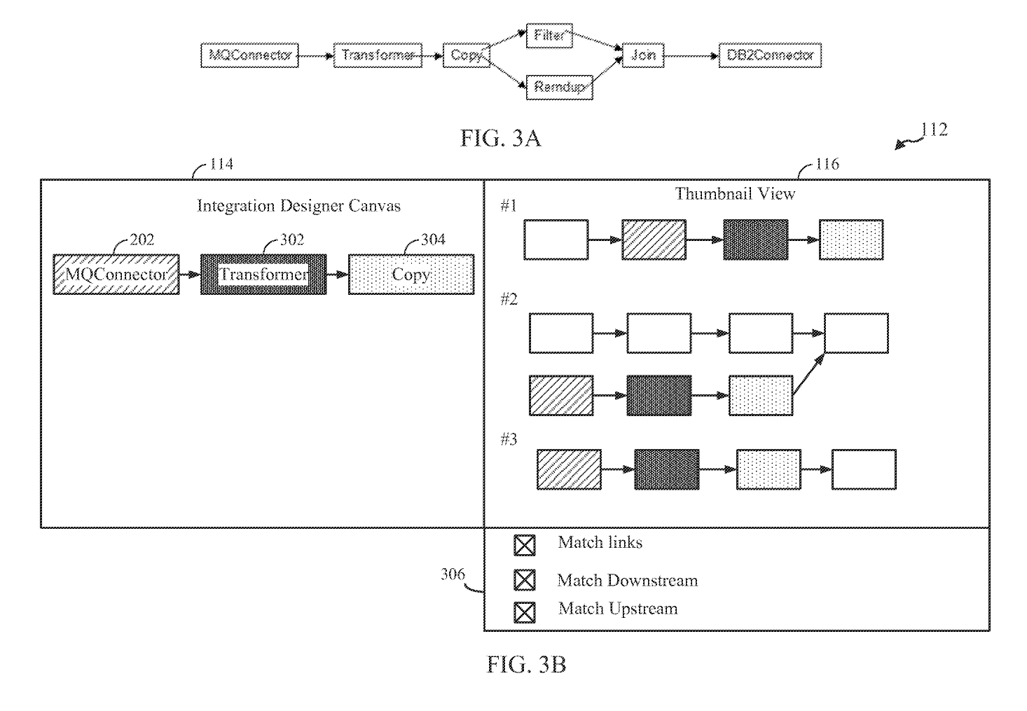

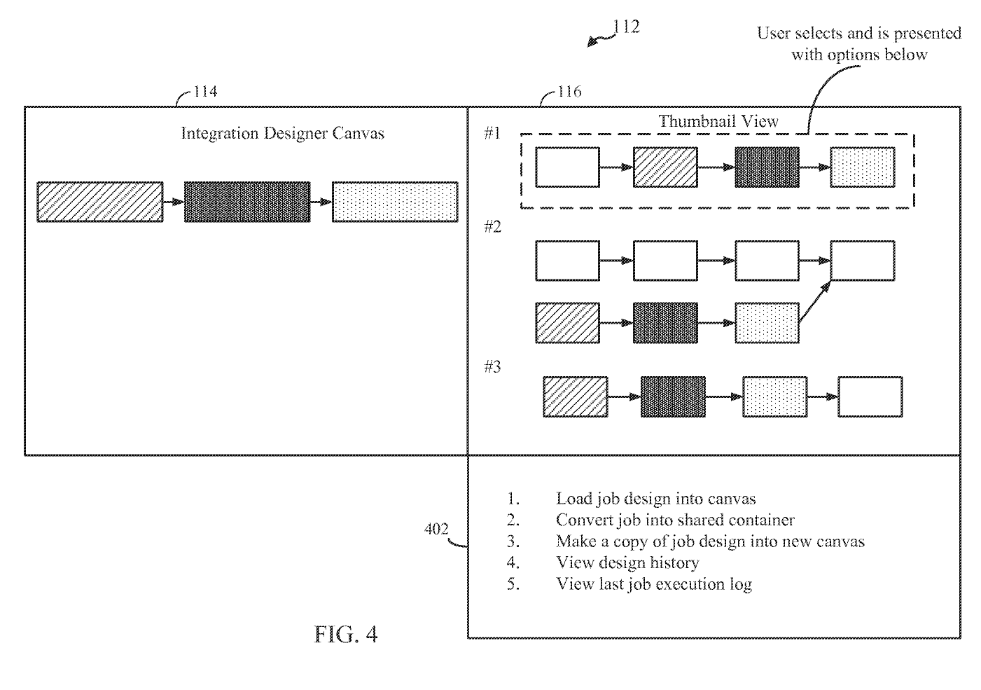

For example, FIG. 3A illustrates an example data flow job design which includes operators linked together in different ways. The multiple operators in this job design are linked together with each other. As illustrated in FIG. 3A, the operators are linked together like a chain (e.g., the MQConnector→Transformer→Copy operators). Another example includes operators linked to the same stage as either an input or an output, e.g., the “Filter” and “Remdup” operators are both connected in a fan-out fashion to the Copy operator as outputs.

As illustrated in FIG. 3B, the user may select multiple operators and links as a matching unit, such as the chain of operators illustrated on the Integration Designer Canvas 114, i.e., the MQConnector operator 202, the Transformer operator 302, and the Copy operator 304. Upon selecting the chain of operators, the job design assistant service 125 may return jobs which match the selected chain of operators, for example, as seen in the thumbnail view 116 of FIG. 3B.

According to certain aspects, the job design assistant service 125 may, by default, provide a look-ahead downstream matching capability. For example, given Transformer operator 302 illustrated on the job design assistant service 125 in FIG. 3A, the job design assistant service 125 may display existing jobs that matches the operator(s) that follow the Transformer operator 302 (e.g., any job that contains the Transformer operator 302 followed by the Copy operator 304).

However, depending on the number of previous jobs stored in the Data Integration Analytical Database 130, the downstream option may return too many candidate jobs for the user to review and select from. Thus, the user may be presented with an option to take into account upstream job design information, may help reduce the number of candidate jobs. For example, given Transformer operator 302 illustrated on the job design assistant service 125 in FIG. 3A, the job design assistant service 125 may display any existing job that matches the operator(s) that precede and that follow the Transformer operator 302 (e.g., any job that contains the MQConnector operator 202 followed by the Transformer operator 302 followed by the Copy operator 304).

If the number of elements in the list still exceeds a threshold, the user may be presented with a window 306 to further narrow down the scope of candidate jobs presented in the thumbnail view 116. For example, the user may specify multiple options (e.g., different stage options, schemas, etc.) and, in response, the system identifies existing jobs that meet each individual match requirement.

According to certain aspects, the user may select a job from the matching jobs in the thumbnail view 116 and presented with options related to that selection.

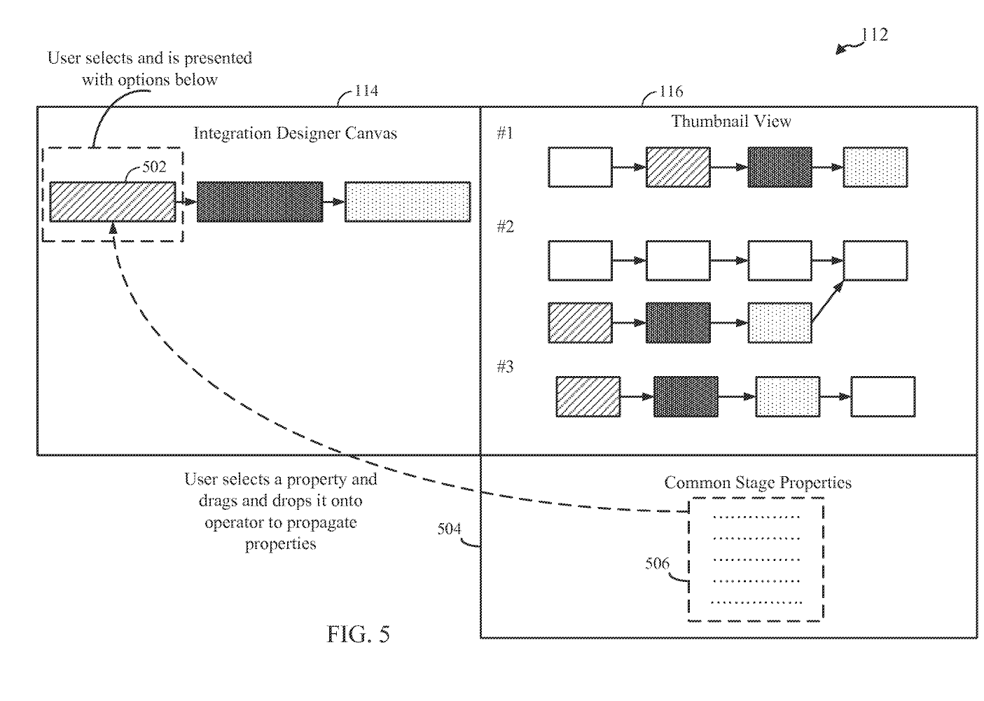

For example, FIG. 4 illustrates an example interface where a user has selected job #1. In response, the design environment 112 presents an options window 402 providing options 1) to load the job design into the Integration Designer Canvas 114; 2) to convert the job into a shared container; 3) to make a copy of the job design into a new Integration Designer Canvas 114; 4) to view the job design history; and/or 5) to view the last job execution log. These options help the existing job designs to be reused more frequently and effectively.

According to certain aspects, a user may select various operator properties for the operators placed onto the Integration Designer Canvas 114.

For example, FIG. 5 illustrates an example where a user selects an operator (e.g., operator 502) in the Integration Designer Canvas 114 to look at the stage properties of the operator 502, the job design assistant service 125 may automatically query the indexing services cache 126 to find a list of unique stage properties settings for the same stage (i.e., operator) referenced in the existing job design (e.g., Job #1) and present them in a window 504 (which may be part of the thumbnail view 116) of the design environment 112.

According to certain aspects, a user may select one or more common stage property(ies) displayed in the window 504 (e.g., common stage property 506) and may drag and drop the selected common stage property 506 onto the operator 502 in the Integration Designer Canvas 114 so that the properties are automatically propagated into the operator 502 as a set. For example, assuming that the operator 502 is an MQConnector, this means that design environment 112 will automatically call the appropriate job design APIs to set the properties for: MQ Server hostname, port number, queue name, username, password, and all other information associated with the MQConnector. Additionally, according to certain aspects, the user may create a parameter set from the selected property by propagating the associated properties and values into a parameter set and then apply the parameter set to the current job.

As illustrated in FIG. 6, job designs (e.g., job design artifacts) may be stored in the Data Integration Analytical Database 130 across multiple indexing tables, which may be queried by the job design assistant service 125 for information matching one or more properties of a data flow operator. For example, a job, regardless large or small, may generally contain at least two stages and one link. Each stage/operator may have at least one option specified (possibly via a job parameter), and must have a schema defined for the link between two operators/stages. Therefore, at a minimum, the job may have an index in several index tables, such as a Stages table 604 that may specify the stages/operators in an existing job and their associated stage options, a Stage Options table 606 that may specify the values of the stage options associated with the stages in the Stages table, a Links table 608 that may specify how two or more stages/operators in the Stages table are linked together and the link number, a Schemas table 610 that may specify schema definitions for each link in the Links table, and a Job Parameters table 612 that may specify parameter values for the stage options listed in the Stage Options table.

According to certain aspects, when a user saves a job, the job design assistant service 125 may analyze the job design in terms of stages/operators, stage options, links, schemas, and job parameters, and may store the job design artifacts accordingly into the tables described above.

The process performed by the job design assistant service 125 will now be described in greater detail with reference to the index tables 602 described above. For example, when a user places an operator (e.g., an MQConnector) in the Integration Designer Canvas 114, the job design assistant service 125 may query the Stages table 604 with a stage type value set to MQConnector. The job design assistant service 125 may then determine a reference list of the first few existing jobs that match the stage type value. According to certain aspects, the determining may be based on the number of stages contained in each existing job. For example, the job design assistant service 125 may display (in the thumbnail view 116) a set of existing jobs with the least amount of stages since the current job only contains one stage. In some cases, the list of existing data flow job designs may be ordered based on how well the existing data flow job designs match the stage type value (i.e., a property) of the operator.

According to certain aspects, as the user adds another stage/operator (e.g., a Transformer operator) and adds links between the two stages (e.g., between the MQConnector operator and the Transformer operator), the job design assistant service 125 queries the Links table 608 with a producing stage type value set to MQConnector and a consuming stage type value set to, for example, Transformer. The job design assistant service 125 then updates the reference list of existing jobs to present jobs with the least number of stages based on the query of the links table 608.

In some cases, the job design assistant service 125 may then query the Schemas table 610 with schema fields specified for the jobs that contain the same link. In some cases, existing jobs found during the Links table 608 query may not be included within the reference list of existing jobs and/or jobs that weren't included in the reference list of existing jobs during the Links table 608 query may be included.

According to certain aspects, if, after the Schemas table 610 query, no existing job designs are returned, the job design assistant service 125 may rebuild the schema fields based on user-defined schemas and those already in the Schemas table 610 and may re-perform the Schemas table 610 query.

According to certain aspects, if after re-performing the Schemas table 610 query, no existing job designs are returned, the job design assistant service 125 may query both the Stages table 604 and the Schemas table 610 as opposed to querying both the Links table 608 and the Schemas table 610.

In some embodiments, when a user selects multiple operators and/or links to query, the approach described above may be used for each operator and/or link. The existing job returned by each operator and/or link search may be considered a match.

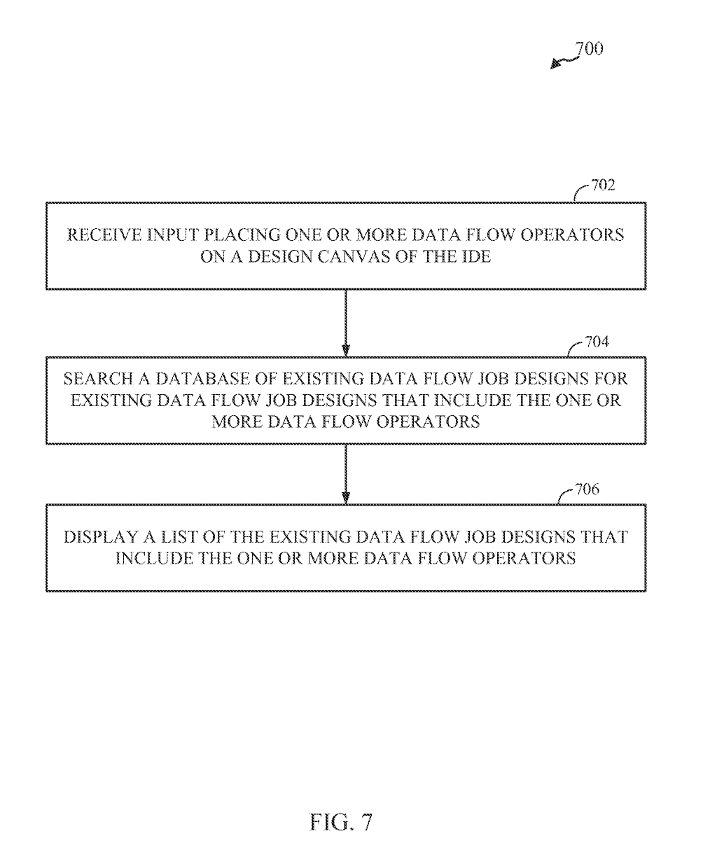

FIG. 7 illustrates a method 700 for re-using existing data flow job designs in a data integration design environment (IDE), according to certain aspects of the present disclosure. The method 700 begins at step 702 by receiving input placing one or more data flow operators on a design canvas of the IDE. At step 704, a database of existing data flow job designs is searched for existing data flow job designs that include the one or more data flow operators. At 706, a list of the existing data flow job designs that include the one or more data flow operators is displayed.

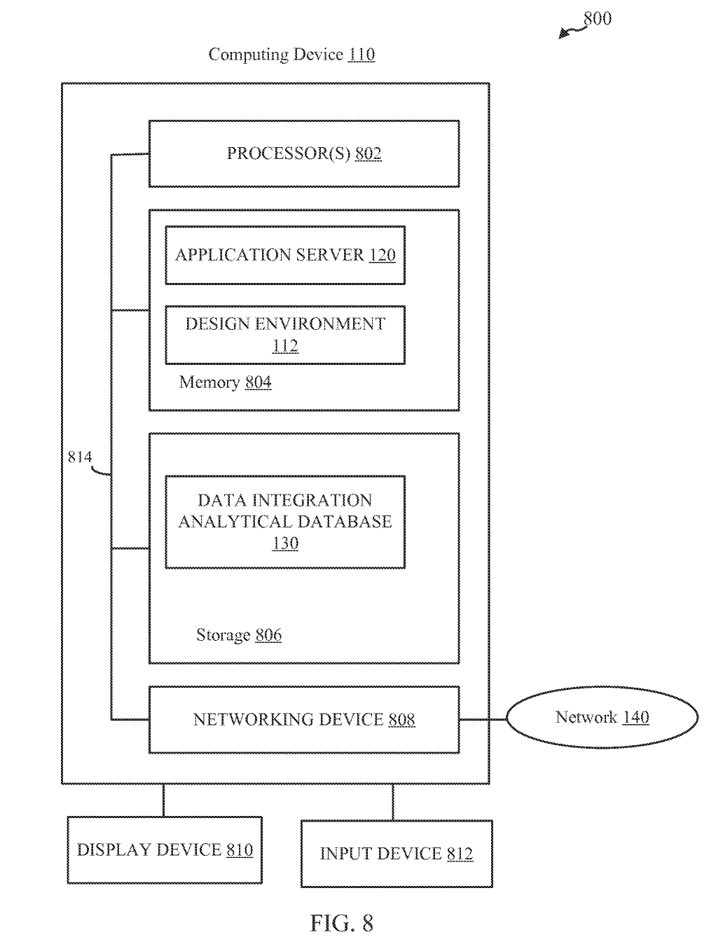

FIG. 8 illustrates an example computing environment 800, according to an embodiment of the present invention. As shown, computing environment 800 includes computing device 110. Computing device 110 is included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Further, although FIG. 8 illustrates a single computer system, those skilled in the art will recognize that embodiments of the invention may be adapted for use on multiple systems configured to communicate over a network, for example, as shown in FIG. 1. Additionally, those skilled in the art will recognize that the illustration of computing device 110 is simplified to highlight aspects of the present invention and that computing systems and data communication networks typically include a variety of additional elements not shown in FIG. 8.

As shown, computing device 110 includes one or more processors 802, a memory 804, storage 806, and a networking device 808, all connected by a bus 814. Computing device 110 may be connected to one or more display devices 810 and one or more input devices 812. Input devices 812 may include a mouse pointing device, a keyboard, pen input devices, and the like. Display devices 810 may include CRT monitors, LCD displays, projectors, and the like. The processing activity and hardware resources on computing device 110 may be managed by an operating system (not shown). Networking device 808 may connect computing device 110 to a data communications network 140, including both wired and wireless networks.

Storage 806 may store application programs and data (e.g., existing jobs) for use by computing device 110. Typical storage devices include hard-disk drives, flash memory devices, optical media, network and virtual storage devices, and the like. As shown, storage 806 contains a data integration analytical database (DIAD) 130 which may store design time metadata about existing data flow job designs, such as the project name, job name, the stages in each job, and/or link information (e.g., schema definitions), according to certain aspects, and as described above.

As shown, memory 804 stores a design environment 112 and an application server 120.

The design environment 112 may be used for visually creating data flow job designs and may be configured to assist in leveraging existing data flow job designs, as described above. While not shown, the design environment 112 may comprise the Integration Designer Canvas 114 used for building data flow job designs and a thumbnail view 116 used for displaying existing jobs that match a user's design intent, as described above.

The application server 120 provides services for leveraging existing data flow job designs stored in the Data Integration Analytical Database 130, as described above. For example, the application server 120 provides the job design assistant service 125 which may, upon a user placing an operator on the Integration Designer Canvas 114, query the Data Integration Analytical Database 130 for jobs that match or contain the operator placed on the Integration Designer Canvas 114, as described above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a data flow design environment) or related data available in the cloud. For example, the design environment could execute on a computing system in the cloud leverage existing data flow job designs and store information defining such existing data flow job designs at a storage location in the cloud. Doing so allows a user to access this information from any computing system attached to a network connected to the cloud (e.g., the Internet).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

1. A method for re-using existing data flow job design in a data integration design environment (IDE), comprising:
receiving input placing one or more data flow operators on a design canvas of the IDE;
searching a database of existing data flow job designs for existing data flow job designs that include the one or more data flow operators, wherein searching the database of existing data flow job designs comprises searching one or more index tables in the database for information matching one or more property settings of the one or more data flow operators; and
displaying a list of the existing data flow job designs that include the one or more data flow operators.

2. The method of claim 1, further comprising:
receiving input specifying at least one data flow job design filter; and
updating the list of the existing data flow job designs according to the at least one data flow job design filter.

3. The method of claim 2, wherein the at least one data flow job design filter comprises at least one of a downstream matching filter, an upstream matching filter, or a links matching filter.

4. (canceled)

5. The method of claim 1, wherein displaying the list of the existing data flow job designs comprises ordering the list of existing data flow job designs based on a measure of how well the existing data flow job designs match the one or more property settings of the one or more data flow operators.

6. The method of claim 1, further comprising:
receiving a selection of one of the displayed existing data flow job design; and
displaying options for using the matching existing data flow job design.

7. The method of claim 1, further comprising:
receiving input to save a current data flow job design; and
saving the current data flow job design in the database of existing data flow job designs according to the one or more index tables.

8. A system, comprising:
a processor; and
a memory storing instructions, which, when executed by the processor, performs an operations for re-using existing data flow job designs in a data integration design environment (IDE), the operations comprising:
receiving input placing one or more data flow operators on a design canvas of the IDE;
searching a database of existing data flow job designs for existing data flow job designs that include the one or more data flow operators, wherein searching the database of existing data flow job designs comprises searching one or more index tables in the database for information matching one or more property settings of the one or more data flow operators; and
displaying a list of the existing data flow job designs that include the one or more data flow operators.

9. The system of claim 8, wherein the operations further comprise:
receiving input specifying at least one data flow job design filter; and
updating the list of the existing data flow job designs according to the at least one data flow job design filter.

10. The system of claim 9, wherein the at least one data flow job design filter comprises at least one of a downstream matching filter, an upstream matching filter, or a links matching filter.

11. (canceled)

12. The system of claim 8, wherein the operations for displaying the list of the existing data flow job designs comprise operations for ordering the list of existing data flow job designs based on a measure of how well the existing data flow job designs match the one or more property settings of the one or more data flow operators.

13. The system of claim 8, wherein the operations further comprise:
receiving a selection of one of the displayed existing data flow job design; and
displaying options for using the matching existing data flow job design.

14. The system of claim 8, wherein the operations further comprise:
receiving input to save a current data flow job design; and
saving the current data flow job design in the database of existing data flow job designs according to the one or more index tables.

15. A computer program product, comprising:
a computer-readable storage medium having computer readable program code embodied therewith, the computer readable program code configured to perform operations for re-using existing data flow job designs in a data integration design environment (IDE), the operation comprising:
receiving input placing one or more data flow operators on a design canvas of the IDE;
searching a database of existing data flow job designs for existing data flow job designs that include the one or more data flow operators, wherein searching the database of existing data flow job designs comprises searching one or more index tables in the database for information matching one or more property settings of the one or more data flow operators; and
displaying a list of the existing data flow job designs that include the one or more data flow operators.

16. The computer program product of claim 15, wherein the operations further comprise:
receiving input specifying at least one data flow job design filter; and
updating the list of the existing data flow job designs according to the at least one data flow job design filter.

17. The computer program product of claim 16, wherein the at least one data flow job design filter comprises at least one of a downstream matching filter, an upstream matching filter, or a links matching filter.

18. (canceled)

19. The computer program product of claim 15, wherein the operations for displaying the list of the existing data flow job designs comprise operations for ordering the list of existing data flow job designs based on a measure of how well the existing data flow job designs match the one or more property settings of the one or more data flow operators.

20. The computer program product of claim 15, wherein the operations further comprise:
receiving input to save a current data flow job design; and
saving the current data flow job design in the database of existing data flow job designs according to the one or more index tables.
